(19) United States
(12) Patent Application Publication
(10) Pub. No.: US 2008/0105101 A1
(43) Pub. Date: May 8, 2008

(54) Split solid body electric guitars

(76) Inventor: Joachim Eldring, Bozeman, MT (US)

Correspondence Address: K. Karel Lambert, P.O. Box 4063, Renton, WA, 98057, US

(21) Appl. No.: 11/593,870

(22) Filed: Nov. 7, 2006

(51) Int. Cl. G10D 3/00

(52) U.S. Cl. 84/291

(57) ABSTRACT

Described are split body electric guitars and electric basses. The guitar body consists of two body plates, a front body plate and a back body plate, the opposing inside surfaces of which are in proximity but not in contact except where joined at a solid core. The body may be shaped to provide internal acoustic chambers, which may be adapted for mounting of electronics. Optionally, an output jack is mounted internally to one of the body plates.

### BACKGROUND TO THE DISCLOSURE

1. Field of the Invention

This invention relates to solid body electric guitars and electric basses; more particularly, to split solid body designs having an open channel formed between a pair of generally coplanar body plates projecting radially from a solid core.

2. Brief Guitar History and Description of Related Art

Various guitar designs have evolved during the history of the guitar. These designs are classified as acoustic, electro-acoustic, and electric guitars. Examples of these three guitar types are illustrated in “The Ultimate Guitar Book” by Tony Bacon.

Before electronic amplification was discovered, all guitars were acoustic guitars. The native acoustic properties of the acoustic guitar body amplified the sound of the vibrating strings. The loudness, sound and timbre of acoustic guitars are almost completely determined by body size, construction and the type of woods used, and in particular by the design and materials of the thin soundboard that forms the front face of the guitar body.

What makes the sound of an acoustic guitar recognizable and interesting to the ear is the rich signature of harmonics (“color” or “timbre”) that overlies the fundamental tone or “note” propagating in the vibrating string. The lowest fundamental string frequencies of a six-string guitar are 82.4 Hz, 110 Hz, 146.8 Hz, 196 Hz, 246.9 Hz, and 329.6 Hz as set by the mass and tensioning of the six strings, but higher fundamental frequencies can be produced by shortening each string at a fret. The frets are precisely spaced to produce the notes of the Western musical scale. These fundamentals are standing, transverse, half waves, in which the vibrating guitar string has two nodals and one antinodal. However, as the transverse wave reflects off the nodes, standing waves at two, three and more multiples of the fundamental frequency are propagated on the string. These more complex standing wave patterns, the overtones or harmonics, determine in measure the color or tonal characteristics of the note as it sounds to the ear. Other harmonics are added by the body itself.

Guitar design has been and remains the product of trial-and-error; of experimentation by craftsmen. Construction is challenging due to the need for proper pitch, durable construction, manufacturability, and beauty in looks. Moreover, theoretical physicists, such as Michael Kasha, are still making new discoveries in the acoustics of guitars, with resulting improvements in design (U.S. Pat. No. 4,079,654; see the Clarita-Negra designs by Boaz Elkayam).

Starting in the 1930s, the desire of guitarists such as Les Paul to play to larger audiences, and the evolution of jazz music, particular big-band jazz music, created a need for a much greater dynamic level than the acoustic guitar body is able to provide naturally.

Therefore, electromagnetic transducers (ie. “magnetoinductive”), a term quickly shortened to “pickups”, were developed to transform the string vibrations into electrical signals that could be electronically amplified, and then reproduced through loudspeakers. The electric guitar was born when these pickups were mounted underneath the strings on the soundboard of an acoustic, hollow body guitar.

There were limits, however, in the level of amplification that could be obtained with hollow body guitars, because of the formation of positive feedback loops—a disturbing, unwanted sound or tone created when the loudspeaker caused an acoustic excitation of the hollow guitar body. During the 1940s and early 1950s this problem was solved thanks to the curiosity, imagination and creativity of people such as, among others, Adolph Rickenbacker, Les Paul and Leo Fender, who designed and built electric guitars having a solid slab of wood as a body. Against the beliefs of their times, they proved that vibrations of paramagnetic strings attached to a solid piece of wood can be electronically amplified to produce a tone that sounded musical.

Hollow body, solid body, and semi-solid body electric guitars all naturally produce, without amplification, unique “native” acoustic sounds that relate to their design, materials and construction.

The body of hollow-body electric guitars consists conventionally of relatively thin sheets of wood of a certain size, thickness and shape (i.e. arched top) that are assembled in a fashion such that they constitute a hollow box to which neck, hardware, electronics and strings are attached. When excited by a plucked string, the bridge vibrates sympathetically, transmitting the vibration to the delicate soundboard that forms the front face of the guitar body. The large surface area of the soundboard amplifies the vibration of the string. “Resonator guitars” were also built on this principle. An innovative example of a hollow body electric guitar is illustrated in U.S. Pat. No. 4,539,886.

The body of a solid-body guitar is traditionally cut from a single slab of wood of a certain size, thickness and shape and is much heavier than an acoustic guitar. Perhaps the earliest solid body guitar was built from a 10 cm×10 cm beam of pine heart. A solid guitar body may also be made by laminating blocks together before shaping. Because acoustic properties vary with the material, the tonal characteristics can be varied somewhat by choice of material, as in U.S. Pat. No. 5,811,703 to Hoshino, U.S. Pat. No. 4,290,336, and US Patent Application 2002/0033088. The effects of various solid body guitar woods, among others, have been described in “Totallyguitar—The Definitive Guide” by Tony Bacon and Dave Hunter, page 26. Molded plastic as an alternate material for the manufacture of solid-body guitars was disclosed by Peavey (U.S. Pat. No. 4,290,336).

The body of a semi-hollow body guitar is a combination of solid- and hollow-body guitar elements. The body consists of thin sheets or laminates of wood that are glued over a solid center block of wood and joined at the outside edges to form a partially hollow box with solid centerboard to which neck, hardware and electronics are attached. An innovative example of this kind of guitar is shown in U.S. Pat. No. 5,682,003.

These three basic guitar body constructions produce characteristic sounds to suit various musical styles, like rock, heavy metal, blues, classical guitar, or jazz, and combinations thereof. However, the craftsmanship and design of guitars is an unpredictable and complex art, and further innovation in body design and construction continues to drive the creative edge of musical expression.

The natural acoustic sound of the various electric guitar bodies, the subtle but characteristic tonal differences of each type, is easily lost or distorted upon amplification. As is known to those skilled in the art, the characteristic properties of the type of pickup contribute significantly to the amplified sound of any particular electric guitar. It was immediately apparent that electromagnetic pickups only pick up the vibration of the strings, and do not transduce the native resonance of the soundboard of the acoustic guitar body with any fidelity. Conversely, the sound of an electric guitar is easily altered electronically by modulating the output of the pickup with frequency filters, such as bass and treble controls, and analogue or digital effects.

Three basic types of transducers are used. These are electromagnetic, piezoelectric, and microphonic.

An electromagnetic pickup is a device, which, through the interaction of a paramagnetic string and a magnetoinductive coil, translates the string vibration into-an electric current. When the magnetic field is altered by vibration of the strings, the coil or coils in the pickup generate alternating current that is then amplified and translated back into sound waves by a loudspeaker. Modern electric guitars typically have more than one electromagnetic pickup, positioned at different points along the length of the strings, so that different tonal qualities can be selected for amplification. Electromagnetic pickups may be single or double coil. The Humbucker double coil was introduced to reduce electrical noise characteristic of single coil pickups.

Also used are piezoelectric pickups. A piezoelectric transducer is a crystal sandwich with a voltage drop that changes in response to pressure on the faces of the crystal. By placing the crystal between oscillating solids, any pressure vibrations in the solids are tracked by voltage oscillations. The under bridge-saddle transducer commercialized by Ovation is an example of this kind of transducer.

Another type of pickup is the microphonic (or “acoustic”) pickup. Air displacement over a microphonic pickup vibrates a metallic plate or diaphragm which, just like a microphone, inductively transforms its vibration into an electric current. All sounds are captured, the vibration of the strings, the resonant overtones of the body, and for example the slapping of the guitar with a hand as well. Importantly, a microphonic pickup also captures the sound of non-ferromagnetic strings such as those made of nylon (see U.S. Pat. No. 5,408,911). Microphonic pickups include dynamic and condenser types.

Musicians and sound engineers have experimented with pickups to capture the native tonal qualities of the guitar body types. A microphone placed in front of an acoustic guitar can capture the characteristic quality of the sound. Combinations of the output from onboard electromagnetic pickups with those of piezoelectric or microphonic pickups return some of the lost acoustic resonant overtones. But the sound of solid body guitars remains mostly dependent on the electronic processing. The resonant dynamics of the instrument itself are believed to have only secondary effects on the sound. And while the use of piezoelectric pickups in a solid body has the potential to enrich the tonal spectrum of the amplified tone with the native resonances of the solid body, the stiffness of a solid body makes it likely that the effects of electronic amplification overwhelm the native resonance.

An inventive variant of electric guitar design aimed at recovering some of these lost resonances is described in U.S. Pat. No. 5,889,221 to Dejima, and consists of top, back and wall elements, wherein a compressible gasket, or “impact absorber” is interposed between the lateral edges of the upper wall and top. In this modified hollow body design, screw bosses situated near the periphery hold the top and back together. The neck is attached to the back wall or panel. Tthe disclosure teaches that a uniquely warm and rich sound is produced.

The Dejima design precedes the modified body design of Vartianen (U.S. Pat. No. 6,774,291), which claims a body comprising “at least two separate parts attached within distance from one another”, [ie. a back body and a top], in which “the attaching parts include a space plate which has been fixed between the top and the back body by screw elements.” The drawings show a back body to which the neck is attached, and a floating top member, attached to the back body at the corners with four laterally mounted metal spacers, named “space plates,” having lug washers, each space plate being fixed in place by three bolts, two into the back body and one into the floating top member, apparently allowing the space plates to flex (U.S. Pat. No. 6,774,291, FIG. 1). The specification teaches, “the attaching parts are located within a distance from the edges of the body” (U.S. Pat. No. 6,774,291, Col 2). This inherent configuration is intended to “make the top and the back body to vibrate independently and to connect them together in the way mentioned earlier as durable and unnoticed as possible” (U.S. Pat. No. 6,774,291, Col 3). Note that the entire top and back body members are believed to vibrate. The neck is connected by bolts only to the back body. The specification further states that, “The vibration of the top and the back body is a part of the electric vibration created by the strings. This is why the vibrations of the top and back body have influence on the sound” (U.S. Pat. No. 6,774,291, Col 4). In disclosing other embodiments, the specification teaches only the use of differing numbers and positions of the attaching hardware, which comprise space plates (U.S. Pat. No. 6,774,291, Col 4), an essential element of the invention as reiterated in the claims. The disclosure teaches that the sound produced by a guitar of the invention is different from that produced by other guitars, “being more airy, warmer and acoustic stronger than that of a solid body guitar” (U.S. Pat. No. 6,774,291, Col 2).

Moreover, by pinning the edges of the top plate to the bottom plate with fixed position bolts in the manner of a beam supported at both ends, as is plainly taught in U.S. Pat. No. 6,774,291, the positions of the nodes of any standing wave in the plates are fixed by the fasteners, and a resonance frequency equal to twice the distance between the nodes divided by the speed of sound in the wood is highly favored, an undesirable condition because the resulting resonance is excited only in a narrow frequency band, a serious drawback. This problem is equivalent to a design of a recording studio in which the walls are parallel at a fixed constant distance from each other, favoring a standing wave at a half wavelength corresponding to the distance between the walls (and the harmonic series of that wavelength) at the expense of the resonance and richness of other notes. It is also not clear whether the Vartianen design is any lighter in weight than conventional solid body guitars.

Given these drawbacks, the problem remains—how to design and construct a lighter solid body electric guitar that has both color and sustain, while adding a unique and distinctive harmonic signature to the range of musical expression.

### SUMMARY OF THE DISCLOSURE

The acoustic qualities of an electric guitar are conventionally described in terms of “color”, “sustain”, and “responsiveness” or “vibe”. Enhancing these qualities in a guitar or bass allows the musician a broader range of musical expression. Disclosed here is a new type of solid body electric guitar with color and full-bodied richness of tone that is distinctive and audible not only in the native pre-amplified mode, but also post-amplification. The character of the amplified tone, of course, is dependent on the type of pickup used.

I teach here that, contrary to popular wisdom, the plate-like body of a solid body electric guitar can have a desirable effect on the tone of the amplified guitar in two ways. String-body modal interaction has been predicted, but the implications may not have been fully appreciated. While not bound by theory, and recognizing that modal analysis is not a complete explanation, a solid body guitar absorbs the energy of a vibrating string as heat in the materials and through the neck joint, bridge and tailpiece, and consequently, the spectrum of that absorption modulates the tone of the guitar. Use of less rigid materials results in more heat dissipated. Therefore, sustain or decay of a plucked string on a solid body guitar responds not only to the additive effects of resonance, but also to the subtractive effects of absorbance.

Solid body design thus can both promote and subdue the development of harmonic overtones. String fundamentals and harmonics are sustained in a solid body guitar because the energy of the string is not quickly dissipated by exciting modal responses in the guitar body. In a stiff body, the harmonics on the string, which are picked up by electromagnetic pickups, are enhanced and sustained. Stiffness along the axis of the neck, bridge and tailpiece, will enhance sustain. Lateral elements that can resonate are a source of color in an instrument. Using these observations, the design of electric solid body guitars is herein improved—I have invented a solid body electric guitar or bass in which the sustain and the mellow character of the resultant amplified tone is surprisingly enriched. The body can also be lightened.

This is achieved by the construction of a solid body guitar formed of two solid body members (termed herein “face body plate” and “back body plate”) having generally coplanar radial projections from a solid core that joints the plates. The front and back body plates are not joined over their entire surface, or joined at the outside edge, but instead are joined at a rigid “stub”, “strut”, “post”, “elevated flat”, “tendon”, “truss”, “neck”, “centerbeam”, or “tongue”. Unlike prior art designs, the outside edge and radial projections of the front plate of the guitar is thus free of contact or attachment with the outside edge and radial projections forming the back plate of the guitar, the only contact and attachment between the two body plates being the solid core element or elements. The body plates are not separate, but are united at a rigid solid core. The outside edge and radial projections have a combined area larger than the area bounding the solid core.

In other words, the front body plate and back body plate are jointed by a solid stub, strut, post, elevated flat, tendon, truss, neck, centerbeam or tongue so as to form a nodal “core” between the body plates, and while not bound by theory, the radial lateral projections of the body members form antinodal and perinodal (or internodal) masses that vibrate (and absorb energy) at frequencies and amplitudes determined by their stiffness, dimensions, and the exciting waveform. Note that the air column in the channel formed between the face body plate and back body plate resonates when excited by the vibrations of the plates, thus amplifying any resonance. The radial projections of the body plates are thus acoustically active and are free to oscillate, exhibiting complex transverse wave modal figures.

Put another way, the front and back body plates are separated by an open channel that “cuts” into the guitar body from its outside edge. As a negative space, the depth of this channel defines the outline of the solid “core”. While the plates can be construed as “shelves” or “fins” mounted on a vertical element, a better analogy might be as follows: in the manner of a stiff three-dimensional tuning fork having leaf-like tongs joined at a rigid junction, the plates can both resonate and dissipate sound energy, thus producing a unique, signature sound with rich, pleasing, color, sustain and mellowness. Extending the analogy, the tongs (here “leaves”) of the tuning fork can oscillate in the manner of a transverse wave, but the center core cannot. Importantly, the solid core of the guitar is held essentially rigid with respect to the long axis of the neck, enhancing the sustain of the string vibration. The body is also lighter and may weigh less than 5 pounds, more preferably less than 3.5 pounds.

In a preferred embodiment, the solid core is formed of a raised T-shaped flat or mounting surface and glue joint between the front and back plates. In another embodiment, the solid core is a raised stub on the front or back body plate whereby the plates are jointed. In another embodiment, the solid core is a projection of the neck joint, and is positioned on the center long axis of the guitar. In these embodiments, the solid core is contiguous with the string attachment assembly. A three-dimensional truss, or space frame is the functional equivalent of a solid core. So is a “through-neck”, fusing the neck, bridge assembly, and tailpiece assembly. In these embodiments, the solid core is functionally equivalent to a single node, and the string attachment mechanism is held essentially rigid with respect to the neck joint, either in the form of a solid or in the form of a truss, or a combination of solid and truss elements that are functionally equivalent to a solid core. These would thus comprise means for forming a solid core.

In a preferred embodiment, the central axis projecting from the headstock to the bridge is stiffened by the manner of the jointing of the neck to the body, and by the positioning of the bridge and tailpiece fixtures at an attachment point or points within the boundaries of the solid core of the guitar.

In another embodiment, the neck joint is not a solid core element, and the neck may be attached to either the front plate or the back plate alone.

A plurality of solid core elements forming a segmented solid core is also envisaged. In one embodiment, three discontinuous solid core elements are formed, one at the neck joint, and one at each of two posts affixing the bridge or tailpiece hardware. In another embodiment, two discontinuous solid core elements are formed, one at the neck joint and another within the outline of the body plates. In selected embodiments, the solid core element or elements is or are not laterally symmetrical, and may be acentrically placed. A line drawn between the outline of each the segmented solid core elements approximates the area of the solid core.

While not bound by theory, the free radial projections of the front and back body plates of the present invention are resonant members. Points at the outside edge of the radial projections function acoustically as antinodes. Acoustic modal analysis could suggest multiple vibrational modes; a unique deformational figure characterized by a relatively high frequency widening and narrowing of the interplate channel as the plates oscillate, expanding and compressing the air in the channel, and a slower (longer) deformational figure characterized by a wave or waves moving along the free edges at the perimeter of the plates. However, because the radial distance R varies continuously around the perimeter of the guitar body, a complex range of resonant frequencies are produced rather than a sharp maximum, no matter the exciting frequency of the strings. These layered resonances serve to dissipate the sound energy of the strings and hence modify the tonal quality amplified by an electromagnetic pickup, or for that matter, other types of pickups as well, producing a signature sound that can be further modified by acoustic chambers dished out from the plates within the interplate channel.

In other embodiments, this signature sound becomes more unique, resonant and vibrant when a piezoelectric or acoustic pickup is incorporated into the body. Piezoelectric pickups can be mounted in or under the bridge, and acoustic pickups may be mounted in the interplate channel, or in acoustic chambers within the interplate channel.

Furthermore, the electric guitar or bass body design and construction described in the present invention allows the craftsman to build a solid body guitar with a larger body without adding significant weight to the guitar. Body weight and the density of the materials used are factors, among others, that determine the tonal signature of the guitar. For example, a light body (or a less dense wood) can be more responsive and vibrant, whereas a heavy body (or a more dense wood) can provide a longer sustain. Conventionally, large guitar bodies deliver a full tone, whereas small bodies can sound tiny and thin. Also, if a heavy (more dense wood) is used then the body size preferably would normally be kept small, because guitar players can't carry a heavy instrument for too long. The design presented herein overcomes this limitation, allowing the guitar builder to use more dense body woods (for enhanced sustain) in combination with a larger body size for fuller tone, without the weight penalty.

In a preferred embodiment, the guitar body has a weight of less than 5 pounds, more preferentially less than 3.5 pounds, yet retains the capacity for a full-bodied tone and pleasing sustain.

In another embodiment, the electric guitar or bass body design and construction described in the present invention allows the craftsman to tune or modify the tonal properties of the instrument during manufacturing by carving or hollowing acoustic chambers out of the lower or front body surfaces forming the internal channel, or both, thus individually altering the acoustic mass of the body members as desired. Synergically, these internally dimensioned acoustic chambers permit discrete placement of the electrical systems of the guitar, enhancing both the aesthetics and manufacturability of the guitar.

In another embodiment, a new neck joint design, as well as a new, internally integrated output jack and jack bracket design is presented in this invention, which augment the acoustic independence of the front and back body members. The jack and jack bracket attach to either the front body or back body plate in a recess in the open channel between the plates, but do not interconnect the plates.

In other embodiments, the interplate channel between the front body member and back body member is canted, arched, or flared, and can have variable width and depth. In other embodiments, the front and back body plates have different or varying thicknesses. In a preferred embodiment, the front and back face of the guitar are generally coplanar with respect to each other.

Construction methods for a guitar embodying the present invention are exemplified in the Examples.

### BRIEF DESCRIPTION OF THE DRAWINGS

FIGS. 1A and 1B show a front plan view and right side elevation of an electric guitar of the invention. The split solid body is most clearly visible in the side elevation. Marked are the front plate (101), back plate (102), and interplate channel (103) of a preferred embodiment.

FIGS. 2A and 2B show a back and left side view of an electric guitar of the invention.

FIG. 3 shows an exploded view of a preferred embodiment of the split solid body and neck assembly.

FIG. 4 shows details of the front plate and back plate of the split solid body, and an example of dished-out acoustic chambers.

FIG. 5 shows a detail of the neck jointing surfaces forming the neck splice joint.

FIG. 6 shows a longitudinal section of a preferred embodiment and details of the plate and neck jointing.

FIG. 7 shows a cross-section of a preferred embodiment and details of the plate and neck jointing. Also highlighted is the use of the acoustic chambers in the interplate channel as a housing for the electronic controls.

FIG. 8 shows a cross-section of an alternate embodiment.

FIG. 9 shows a longitudinal section of an alternate embodiment.

FIG. 10 highlights a detailed exterior view of the unique output jack socket and mounting bracket in the interplate channel.

FIG. 11 shows an interior close-up of the output jack and mounting bracket affixed to the back plate.

FIG. 12 shows alternate solid core jointing surfaces of solid body electric guitars of the invention in coronal section.

FIG. 13 shows an alternate solid body style of a 6-string electric guitar. Note the canted interplate channel in the side elevation view and section. Note also the alternate features of the dished out acoustic chambers in the sectional view.

FIG. 14 illustrates three sketches of a monolithic “through-neck” projecting from headstock to tailpiece. The solid core jointing surface in this model is contiguous with the neck.

FIG. 15 illustrates another alternate embodiment of a solid core. The solid core is a monolithic centerbeam projecting from headstock to tailpiece and is rabbeted to accept front and back plates that slide on from the butt of the beam.

FIG. 16 shows the headstock of a guitar and string tree with tuning knobs.

### DETAILED DESCRIPTION OF THE INVENTION AND DRAWINGS

### 1. DEFINITIONS

The anatomy of a guitar is defined by the following terms. A “headstock” is attached or can be an integrated part of the “neck” of the guitar. On the headstock there are machine heads, also known as “tuning keys,” and a “string tree”, on which the strings are wound and tightened. At the point where the headstock meets the neck of the guitar, there is a generally small crosspiece of material (metal, plastic, bone, etc.) called the “nut,” in which small grooves are carved in order to guide the strings up to the tuning mechanism. The neck of a conventional guitar projects to the body of the guitar at the upper “bout”, and it supports the “fret board” of the guitar, which in turn supports the frets (generally metal strips) embedded in it at mathematically spaced points along the length of the neck. The strings of the guitar run from the machine heads, over the nut, down the neck, across the body and the sound hole (if present), across the saddle of hardware termed the “bridge,” and finally are anchored to the body by a “tailpiece.” A “soundboard” and “sound hole” are used in acoustic guitars to amplify and modulate the vibration of the strings. “Pickup” transducers positioned under the strings anterior to the bridge on or in the body of an electric guitar are used to further amplify and modulate the sound produced by the guitar when played.

Solid core: is the essentially rigid volume extending from the top face of the front plate to the bottom face of the back plate that joins the plates and functions as an acoustic node. The solid core may thus consist of solid core elements selected from “stub”, “post”, “elevated flat”, “truss”, “tendon”, “neck”, “centerbeam”, “tongue”, or a combination of these elements, and may be monolithic, generally contiguous, or segmented (ie. discontinuous). A truss or space frame extending through the neck joint is a solid core volume if the string attachment mechanism is substantially rigid with respect to the neck and headstock, thus enhancing sustain. In one sense, the solid core volume comprises one or more “mounting surfaces” where the two body plates are joined. Jointing may be by means of pegs or hardware, by adhesive, or by a combination of adhesive and fittings. In another sense, a coronal section (ie. parallel with the interplate channel) through the solid core demarcates an area or “footprint” on plan view within which the front plate and back plate are made essentially rigid. This footprint is taken as the area in any coronal section transecting the interplate channel that is occupied by a solid core element or elements plus all area lying between any pair of solid core elements. This definition grasps the inherent rigidity of a limited space bounded by relatively rigid elements and plates. A truss or space frame may be about as rigid as a solid block, but much lighter. The area of the solid core in coronal section may be less or equal to one half the area of the top face of the body, more preferably less or equal to one third of the area of the top face, and in some embodiments, less than one quarter of the area of the top face. Conversely, the area of the top face of the body outside the boundaries of the solid core may be greater than the area within the solid core. In all embodiments, an “interplate channel” separates the radial projections of the body plates around the solid core. These radial projections are not vibrationally constrained as is the solid core.

Interplate Channel: The radial projections of the body plates project from the solid core and form the walls of the interplate channel that separates them. A breadth of said interplate channel is any separation distance between the two body plates, and a depth of said interplate channel is any plumb distance from the outside edge of the body to the solid core. The interplate channel is in one sense the negative space defining the boundary outlining of the solid core.

Radial: While “radial” is often defined as “lying on a radius”, the word as used here more broadly connotes “lying on a horizontal line from any point in plan view on the boundary outlining the solid core area to any point on the outside edge of a body plate”. The radial projections of the body plates thus have an area which can be computed by calculating the area of the top face minus the area of the solid core.

“Radial projection”: is a projection of a body plate from a solid core to a peripheral edge of the body. The mass of a body plate making up a radial projection is supported only at the solid core. A radial projection is thus supported only at one end, in the manner of a cantilever or shelf, and can oscillate in response to acoustic excitation in modes entirely unlike the acoustic response of a beam supported at two ends. While not bound by theory, in one mode, the solid core is a node and the peripheral edge of the radial projection is an antinode. The radial projections of the two body plates are generally coplanar and are capable of sympathetic oscillations.

Nodal or “node”: the fixed end of a transverse wave (such as a standing wave on a string) where the amplitude of the wave is zero. One full sinusoidal wave has three nodals. A half wave has two nodals. A quarter wave has one node.

Antinode: is the center of a sinusoidal transverse half wave on a string where the displacement amplitude is maximal. An antinode lies between two nodes on a string. With respect to pressure waves, the antinode is found where the pressure fluctuation is maximal. Internodes are intermediate between node and antinode.

Standing Wave: Stringed instruments produce musical tones by trapping waves of specific lengths between nodes on the string. The standing waves on a string can only have certain lengths as determined by the separation distance between nodes. However, standing waves may also be superimposed multiples of the fundamental frequency.

Transverse Wave: A transverse wave describes the vibration or modal figure of a vibrating string or other mass, and must be differentiated from a pressure wave, such as a sound wave emanating in the air by compression.

Pitch: Pitch describes a sound as heard by the ear, and is interchangeable with the wavelength or frequency of a sound wave in air.

Color: One of the basic elements of music is called “color,” or “timbre”. Color includes higher harmonics and overtones. A guitar and a flute, for example, have differences in sound; it is these differences that are the color of the sound. The harmonics at the beginning of each note—the attack—are especially important for color.

Sustain: The duration of vibration of a plucked, undampened string; the duration of the tone.

Vibe: is a term used by musicians to describe the responsiveness and liveliness of an instrument. Good “vibe” means that the instruments responds quickly, has good sustain and develops a rich harmonic overtone spectrum.

Reverberation: A note played in a small space will reverberate. Reverberation, also termed “verb”, is nothing more than lots and lots of little echoes, but also can be produced electronically.

Dynamic level: The loudness or softness of a sound.

Resonance: refers to the sympathetic vibration of two objects sharing a natural resonance frequency. Natural resonance frequencies are determined by the vibrational modes of the material and its dimensions.

Harmonics: refers to standing waves or overtones at integer multiples of a fundamental frequency.

Modal analysis: is the process of extracting the dynamic characteristics of a vibrating system from experimental transfer functions. The dynamic characteristics of interest are the mode shapes and modal parameters. A mode shape is a deformational shape defined by relative amplitudes of the limit positions of motion of a solid in a system at a single natural frequency. The modal parameters are the natural frequencies, damping ratios, and modal masses associated with each of the mode shapes. A mode shape is a global property of an elastic system. That is, each mode shape is associated with a specific natural frequency and damping ratio which can be extracted from almost any system transfer function.

For example, 90 Hz, 180 Hz, and 786 Hz are natural resonant frequencies of a Gibson J-45 acoustic guitar. Amplitude peaks are found near the middle of the soundboard rather than at the edges, which one would expect. The 90 Hz and the 786 Hz resonances have higher amplitudes than the 180 Hz.

Truss Rod: a metal or fiber composite rod fitted inside the neck, typically threaded and almost always adjustable, that is used to control neck relief. There is usually an access hole on the headstock, covered by a decorative plate, or in the neck head. See also U.S. Pat. No. 6,884,932, included herein by reference.

“Conventional” is a term designating that which is known in the prior art to which this invention relates, particularly that which relates to electric guitars.

“About” and “generally” are broadening expressions of inexactitude, describing a condition of being more or less, approximately, or almost, where variations would be obvious, insignificant, or of equivalent utility or function, and further indicating the existence of obvious exceptions to a norm, rule or limit.

Herein, where a “means for a function” is described, it should be understood that the scope of the invention is not limited to the embodiment or embodiments illustrated in the drawings alone, but also encompasses other means commonly known in the art at the time of filing and other means for performing the equivalent function that are described in this specification. Any “prior art means” encompasses all means for performing such function as are known in the prior art.

### 2. DETAILED DESCRIPTION OF THE DRAWINGS

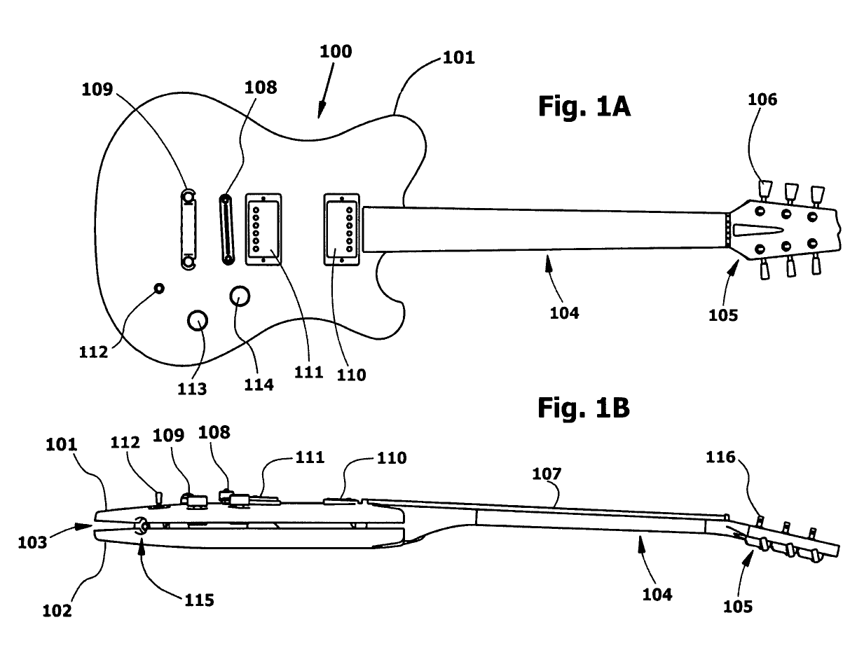

FIG. 1A shows a top plan view of the solid body (100) of an electric guitar or bass, with front plate 101, neck 104, and neck headstock 105, to which the string tuning mechanism 106 is attached. Also shown are electromagnetic neck pickup 110 and bridge pickup 111, bridge 108, and tailpiece 109. Control interface members 112, 113 and 114 are for pickup selection, tone, and volume respectively.

FIG. 1B is a side elevation view of the right side of the electric guitar in a preferred embodiment. The guitar body consists of the front body plate 101, also called “face plate”, and the back body plate 102, also called “back plate”. The front body plate and back body plate are also termed, “the plates”. The front and back body plates are jointed at a solid core and are separated where not jointed by an interplate channel extending from the outside edges of the body to the solid core. The depth and width of this channel (103) may be varied.

Labelled for reference in the elevation view are hardware elements on the front face: pickup selector (112), tailpiece (109), bridge (108), bridge pickup (111) and neck pickup (110). The fretboard 107 is shown in its customary position on top of the neck (104) and the string tree posts (116) are shown as assembled on the headstock 105. A recessed output jack (115) is positioned in the interplate channel 103, where it is mounted on the base plate (102) in such a way that it is not in contact with the front plate (101).

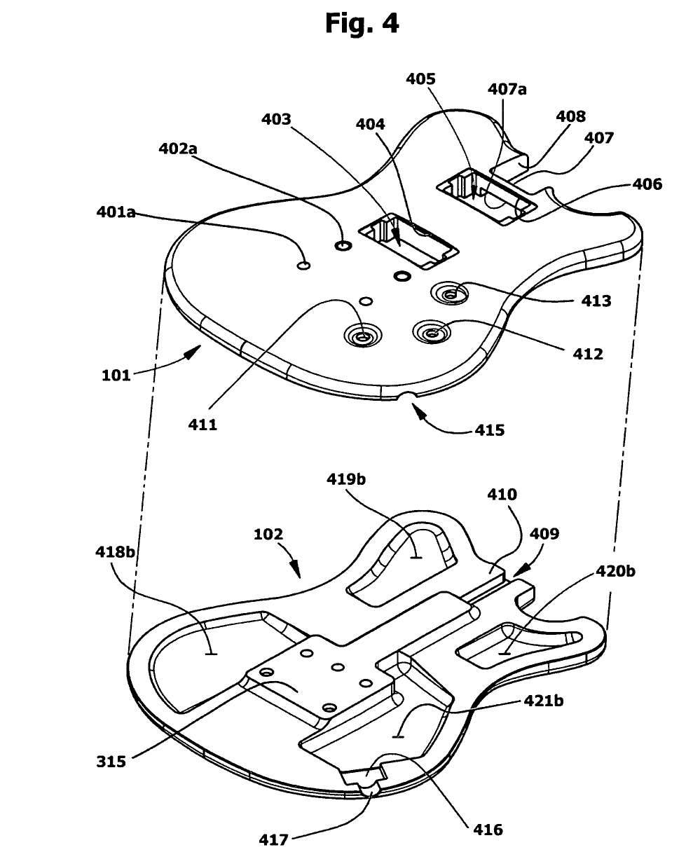

In a preferred embodiment, the interplate channel 103 has an interplate plate separation or breadth of about 5 mm, or approximately 3/16 inch, between front and back body member. However, the present invention is not limited to this distance. Interplate separation breadth is necessarily greater than the maximal amplitudinal displacement of the opposing plates, and is less than the greatest separation at which a comfortable body design is no longer feasible. The interplate separation breadth, and the thickness of the front and back body members, are not required to be constant and may be variable in order to achieve acoustic effects. The front and back body plates need not be parallel but may generally be so. Variation of the interplate channel width is also achieved by carving out acoustic chambers in the plate interiors, as is described in FIG. 4.

In preferred embodiments, interplate separation breadth is 0.5 mm to 7 cm as measured at the perimeter of the plates. In more preferred embodiments, interplate separation breadth is 2 mm to 5 cm. In a preferred embodiment, interplate separation breadth is about 5 mm.

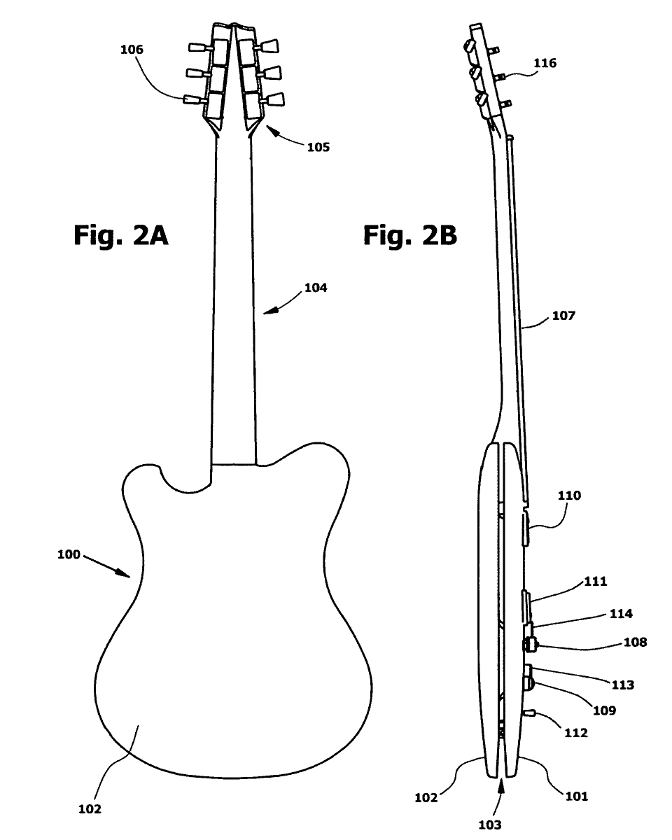

FIGS. 2A and 2B shows the back and side view of a preferred embodiment of a split-body 100. Shown in elevation are the front plate 101, back plate 102 with back face, interplate channel 103, pickup selector 112, tailpiece 109, tone control 113, bridge 108, volume control 114, and two pickups 110 and 111. Also shown are the neck 104, headstock 105, tuning keys 106, fret board 107 and string tree 116 of the fully assembled electric guitar.

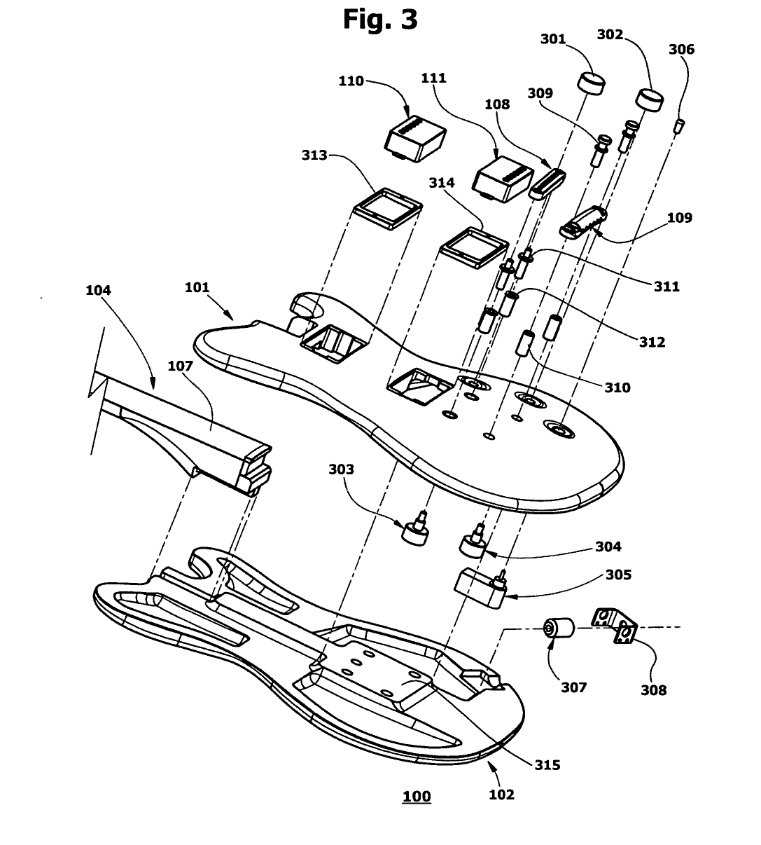

FIG. 3 shows an exploded CAD view of the electric guitar body and neck splice jointing. Strings and electric wires are not shown for clarity. The components of the guitar in the preferred embodiment of this figure include guitar body 100, comprising front plate 101 and back plate 102; the string attachment mechanism with bridge 108 and tailpiece 109; a pair of bridge threaded studs 311 and paired bushings 312; a pair of tailpiece studs 309 and paired bushings 310; the neck pickup 110 with pickup mounting frame 313; bridge pickup 111 with pickup mounting frame 314; volume control 303 and volume knob 301; tone control 304 and tone knob 302; pickup selector switch box 305 and switch knob 306; and output jack with socket, housing 307 and jack mounting bracket 308. Note that the electronics fit in the interior of one of the dished-out acoustic chambers in the back plate, and are attached to the underside of the front plate in a corresponding dished-out chamber (not shown). Control knobs are optionally mounted (as shown here) on the face of the front plate and form a control interface.

Other on-board electronic components contemplated include an op amp, treble and bass controls, tremolo control, vibrato, a wa-wa bar, battery, speaker, a wireless transmitter, pickup selector, output jack, piezoelectric pickup, microphonic pickup, and shielding. In one option, a piezoelectric pickup can be inserted between the bridge and the front of the solid body. In another option, a microphonic pickup can be mounted in the interplate channel or in an acoustic chamber of the guitar body.

The string attachment and tuning mechanisms are conventionally made from metal, or a combination of metal, plastics or plastic composite material. One kind of string attachment means is known as the “Tune-O-Matic” bridge and tailpiece and is used by many guitar manufacturers.

Although a preferred embodiment of the present invention is shown with a certain configuration and types of mechanical hardware and electronic components, the invention is not limited to any configuration or type of hardware or electronic components. Other string attachment means are known in the prior art.

Also labeled in FIG. 3 are the neck 104 and fret board 107. Solid core element 315 serves as a jointing surface and is described further in FIG. 4. In this preferred embodiment, the solid core provides points of attachment for the string attachment mechanism.

FIG. 4 is a three-dimensional CAD rendering of a preferred embodiment showing (upper) the front plate 101. The front plate is drilled with hole pairs 401a,b and 402a,b for tail piece and bridge assembly (string attachment mechanism), and holes 411, 412 and 413 for assembly of pickup selector switch, tone and volume controls respectively. Dished receptacle 415 (with 417) enables plugging an audio cable into the output jack 307 (FIG. 3).

The front plate is also milled to form neck mounting surfaces 407 and 408 and pickup receiving receptacles 403 and 405. Mounting surface 407a is an undercut for accepting the neck tendon. Recessed mounting surfaces 404 and 406 accommodate pickup mounting frames 313 and 314 (FIG. 3). The present invention is not limited to any particular configuration of the pickups or pickup mounting holes. Other pickup means are known in the prior art.

Generally, the body plates are made of solid pieces of wood, such as mahogany or oak, or a composite material, such as carbon fiber composite, or a combination of wood and epoxy/carbon fiber, or polyacrylate/polyester composite elements, such as a laminate, but are not limited to any of these materials. Spruce, mahogany, rosewood, alder, basswood, swamp ash, noble fir, or heavier and harder woods such as maples, walnut, Hawaiian koa, or karin, for example, can be used. For the neck, rosewood, maple or ebony can advantageously be used.

Among these woods, various kinds of maples and burls have a marbled or whorled grain, which is capable of offering a peculiar body surface in terms of outside appearance, with an added variation in terms of sound quality as compared with a body made of an isotropic material.

Woods may be selected for their acoustic properties. Woods vary substantially in the speed of sound, and slower speeds of sound in the material are indicative of more dissipative loss of energy from the sound wave as heat. Woods are also characterized by anisotropic conductance of sound; that is, the speed of sound along a grain is typically faster than across a grain, and this may be desirable.

Plastics, which can be fabricated to be isotropic to sound, may also be used. Voids inside the body plates can be used to further control the resonance and sustain of the guitar.

Furthermore, each body plate can be a solid of a selected size and thickness, for example a hollowed half shell with a thickness, or a solid of a certain size and thickness having dished-out acoustic chambers of the kind shown in FIG. 4 (on the back plate: 418b, 419b, 420b, 421b).

FIG. 4 (lower) is a CAD rendering of the back plate 102 of a preferred embodiment and reveals structure on its inner surface corresponding to the internal dimensioning of the interplate channel.

In this embodiment, back plate (and front plate) are milled to form acoustic chambers 418, 419, 420 and 421. Shown here are the back plate acoustic chambers 418b, 419b, 420b, and 421b. Not shown are corresponding front plate acoustic chambers 418a, 419a, 420a, and 421a. Chambers 421a/b also serve as a space for mounting electronic components, controls for the user interface, and for wiring. Acoustic chambers 418, 419, and 420 are optional. The present invention is not limited to the number, size and shape of the acoustic chambers, which modulate the acoustic properties of the guitar.

Recessed shelf 416 and dished receptacle 417 form a mounting surface for the jack mounting bracket 308 (FIG. 3). Receptacle 417 enables plugging an audio cable into the output jack 307 (FIG. 3). The jack housing 307 and jack mounting bracket do not contact the front plate.

The “tee-shaped” raised solid core element (see definition of “solid core”) in the center of the back plate serves as a mounting surface between the front and back plates in the fully assembled guitar. During assembly of this embodiment, glue is applied to the raised flat surface of 315 and the two plates are pressed together. Front and back plates are aligned as shown in the figure.

The height of raised solid core element 315 above the plane of neck mounting surface 410 defines the breadth of the interplate channel. Other solid core element mounting surfaces are contemplated.

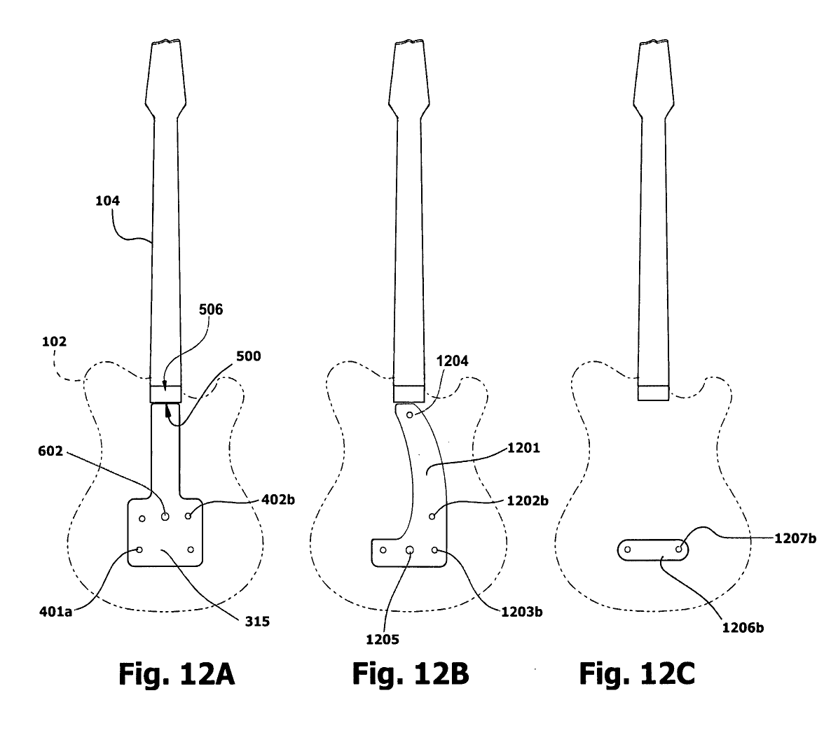

The present invention is not limited to this solid core element geometry and, for example, solid core element 315 can be formed instead from the front plate or can be formed in part from both body plate members. Other embodiments of the genus of solid core elements contemplated in the invention are described in FIGS. 12 through 15.

In FIG. 4, note that the neck joint also forms a solid core element of the final assembly. Neck mounting surface 410 and rabbet 409 mate to the neck undersurface and toe. The neck and tendon also mates with mounting surfaces 407 and 408 in the front plate. The neck, front plate, and back plate are glued together during assembly. Alternatively, the neck can be mounted to the back plate using pegs, bolts or wood screws, or a combination of fittings and adhesive. Other attaching means as known in the prior art are also contemplated. Details of the neck joining surfaces are shown in the following figure.

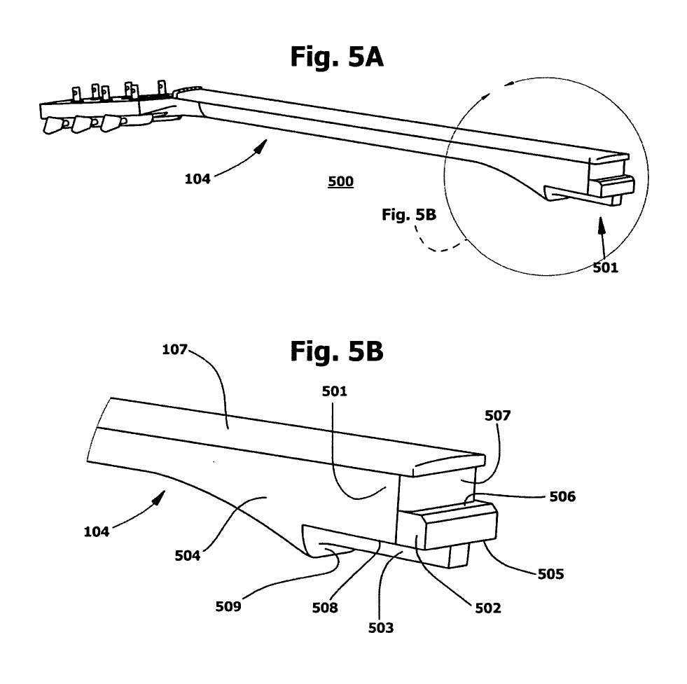

Turning to FIG. 5, the guitar neck assembly 500 and neck head 501 are rendered in perspective. Neck head 501 is enlarged in FIG. 5B. The neck head 501 consists of the neck tendon 502, neck toe 503, neck heel 504, neck tendon front 505, neck tendon shelf 506, neck head front 507, neck undersurface 508, neck heel front 509, and neck head lateral faces 510.

In assembly, the neck toe 503 and mounting surfaces 508 and 509 are glued to mated surfaces 409 and 410 on back plate 102. Mounting surfaces 506 and 507 of the neck tendon 502, and the lateral surfaces of the neck 510, are glued to mated surfaces 407, 407a, and 408 on front plate 101. Advantageously, the gluing of the neck and the body plates (including mounting surface 315) can be completed in a single step.

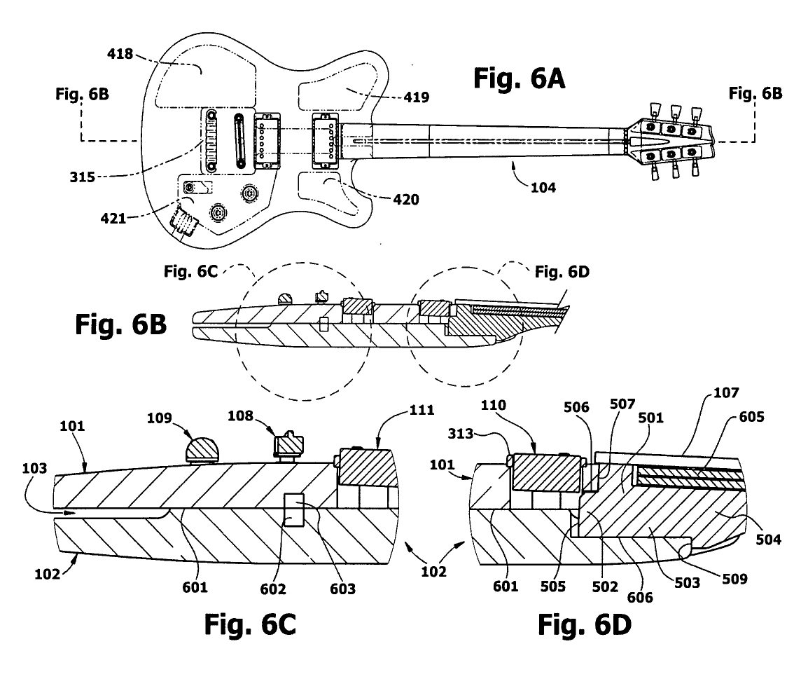

Turning to FIG. 6A, the central “tee-shaped” solid core element 315 is represented by a dashed line in plan view. The position of acoustic chambers 418, 419, 420 and 421 in FIG. 6A also are indicated by dashed lines. The location of longitudinal section of FIG. 6B is drawn along the center axis of the guitar body and neck.

FIG. 6B is an elevation view of the longitudinal section on plan view. Details 6C and 6D are enlarged in FIGS. 6C and 6D. FIG. 6C details glue joint 601 between front and back body plates 101 and 102. Also shown for reference are string attachment mechanism members 108 and 109, and bridge pickup 111. The blind holes 602 and 603 are used for alignment of front and back plates 101 and 102 during machining and assembly of the guitar body.

Solid core element 315, with glue joint 601, joins the plates along the center axis of the guitar and under the string attachment mechanism. Therefore, it results naturally in a “tee” shape. However, the present invention is not restricted to any particular form, size and location of the solid core elements between front and back body members, but the combined area of any solid core elements present is less than the total interplate surface area (see FIG. 12). The combined area of the solid core of this embodiment includes glue joints 601, 606 and 607.

FIG. 6D is an enlargement of the neck joint, showing neck glue joints 606 and 607. Mounting surfaces 503 (out of sectional plane), 508 (seen in FIG. 5), 506, 507, 509 and 510 join neck head 501 and the front and back plates 101 and 102. Note that the front and back plates are not directly bonded together at the neck/body joint. Front and back plates are indirectly connected through the neck head 501 as follows: The back body member 102 is affixed by glue joint 606 to the neck undersurfaces of 508 (FIG. 5B), 509 and toe 503, at the interfaces 409 and 410 (FIG. 4). The front plate 101 is joined to mated surfaces 506 and 507 and also laterally at surfaces 510 (FIG. 5B) at glue joint 607. The neck tendon 502 thus acts as a shelf 506, supporting the front plate. Neck head 501, truss-rod 605, and fret-board 107 are elements of the neck assembly 500. A neck slab board is optional.

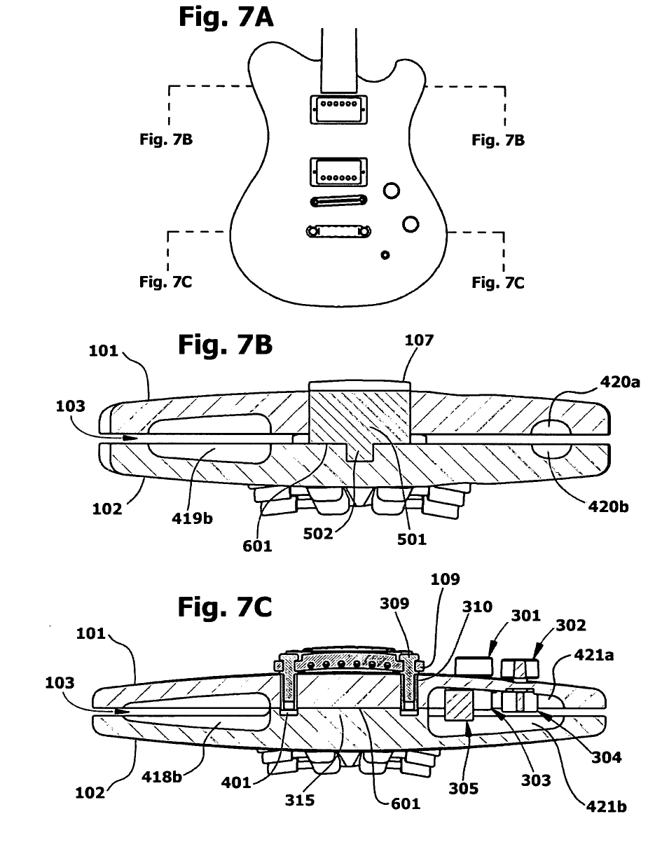

FIG. 7A shows the plan view of the electric guitar body (the neck is partially shown) and two cross-sections. Upper cross-section 7B is taken through the neck joint and shows the front and back body plate glue joints 606 and 607 from a viewpoint that is perpendicular to that of FIG. 6D. Lower cross-section 7C is take through the tailpiece and attaching hardware, and illustrates glue joint 601 and solid core element 315 from a viewpoint that is perpendicular to that of FIG. 6C.

FIG. 7B illustrates lateral radial projections of plates 101 and 102 and interplate channel 103 between the plates. The radial projections of the plates, including the dished-out acoustic chambers 419a, 419b, 420a and 420b, can thus vibrate freely in the manner of a cantilevered member supported only at one end.

Cross-section FIG. 7C through tailpiece 109 includes mounting hardware 309 and 310 within holes 401a and b, where “a” and “b” denote left and right respectively. Glue joint 601 is the upper face of the “tee-shaped” raised solid core element 315 (see definition of “solid core”) in the center region of the back plate, and forms a contiguous interface between the front and back plates in the fully assembled guitar. Neck glue joints 606 and 607 (FIG. 7B) described above form a second solid core element. In this section, radial projections of plates 101 and 102 are seen projecting laterally from the combined solid core. The radial projections of the front and back plates are thus free to vibrate freely over a large area, including dished-out acoustic chambers 418a, 418b, 421a, 421b, 419a, 419b, 420a and 420b.

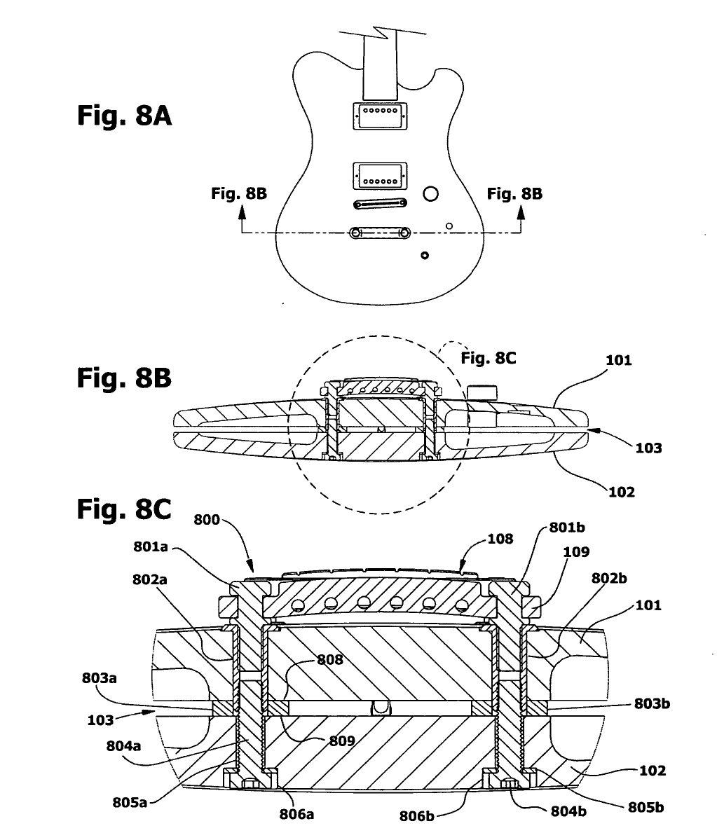

Turning now to FIG. 8A, the illustration shows a plan view of an alternate embodiment of an electric guitar or bass of the present invention. An alternate jointing is is shown in cross-section 8B. Studs joining the tailpiece to the upper plate are nested in a long bushing that also accepts bolts from the underside of the guitar body. This is shown in more detail in the enlarged view 8C.

FIG. 8C details solid core element 800 of this embodiment. Here the solid core element consists of the attaching hardware for the tailpiece 109, including studs 801a/b, bushings 802a/b, and also countersunk bolts 804a/b, and inserts 803a/b. Also shown are washers 805a and 805b that offer protection for the bolt seating surfaces in the back body plate.

Standoffs 803a/b form a solid union between the two plates by compression and optionally by gluing at mounting surfaces 807 and 808. Inserts 803a and 803b are rounds with a diameter and thickness and having a center hole of a diameter smaller than the diameter of the round. The breadth of the interplate channel is determined by the thickness of standoffs 803a and b. Expanding on the definition of “solid core”, the illustrated embodiment comprises a union between front and back plate members wherein the solid core elements are essentially “posts” forming a solid volume in cross-section from top to bottom of the plates-part composed of hardware, other parts composed of wood or plastic, and the inter-element volume made generally rigid between the solid core elements. The stiffness of these solid core elements is significantly greater than that of the surrounding radial projections of the plates, and the solid core acts as a rigid acoustic node. In one sense, the footprint of the solid core can be viewed as triangular, with the neck joint and the two rounds forming the vertices of the triangle, wherein the rigidity of the inter-element volume demarcates the area of the solid core. Because this solid core is relatively small in area, the radial projections of the front and back plates are thus free to vibrate freely over a larger area, including any dished-out acoustic chambers within the body.

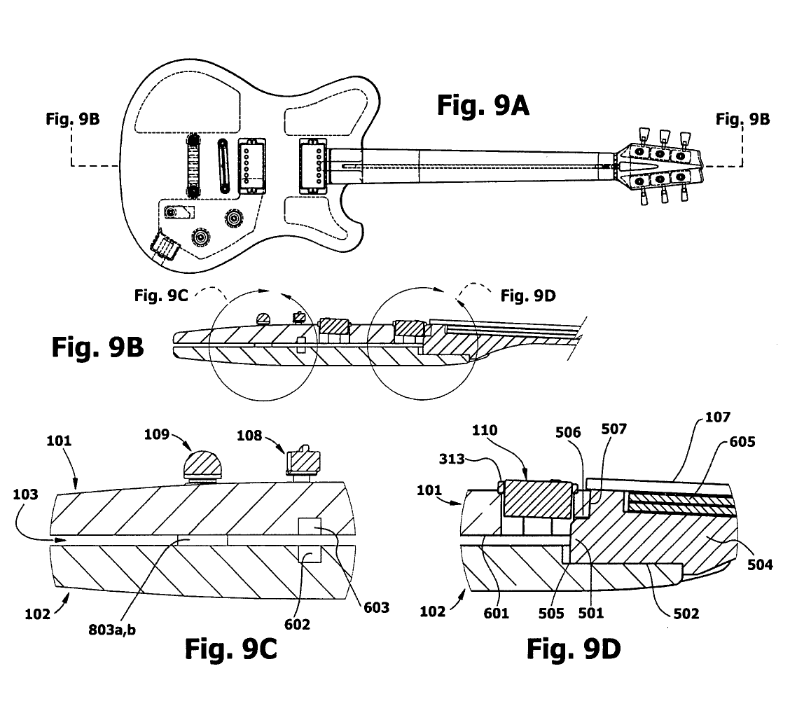

FIG. 9A is a plan view the guitar and the location of longitudinal section 9B on the centerline is marked. FIG. 9B is an elevation view taken along the longitudinal section, and indicates where enlarged views 9C and 9D are taken.

FIG. 9C details the solid core element at inserts 803a/b, which are held in place by the tailpiece attaching hardware (not shown in this section), and optionally glued.

FIG. 9D describes a neck glue joint similar to that of FIG. 6D, and which functions as a solid core element. The solid core footprint of this design is small, providing a large area for the body plates to vibrate.

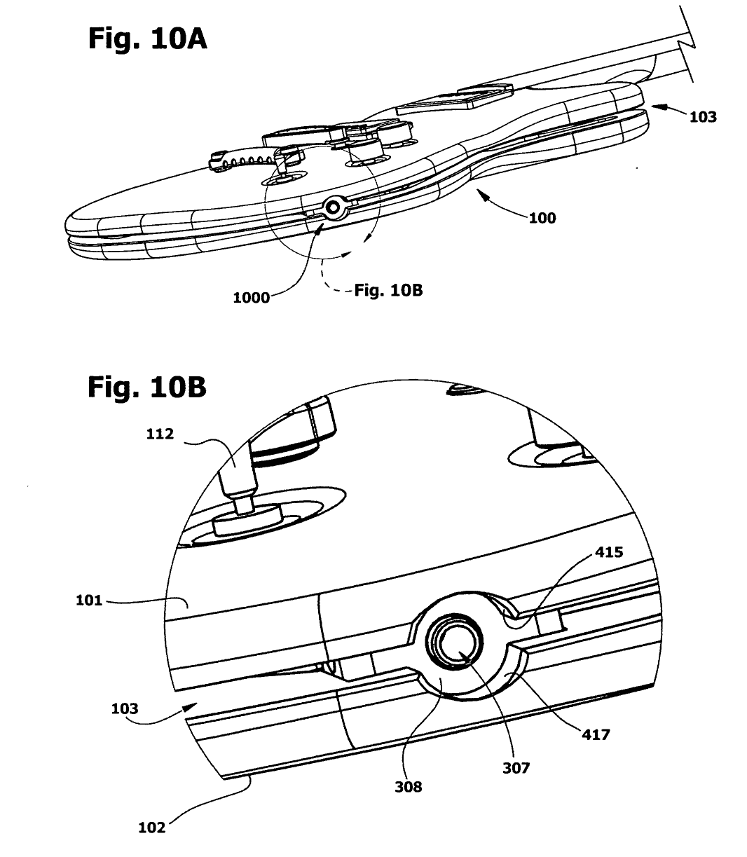

FIG. 10A is a CAD rendering of a right side view of the body 100. Output jack 1000 recess in interplate channel 103 is shown in perspective. An enlarged view, FIG. 10B, shows the internally integrated output jack 307 with jack mounting bracket 308, as well as the audio cable access receptacle consisting of 415 and 417.

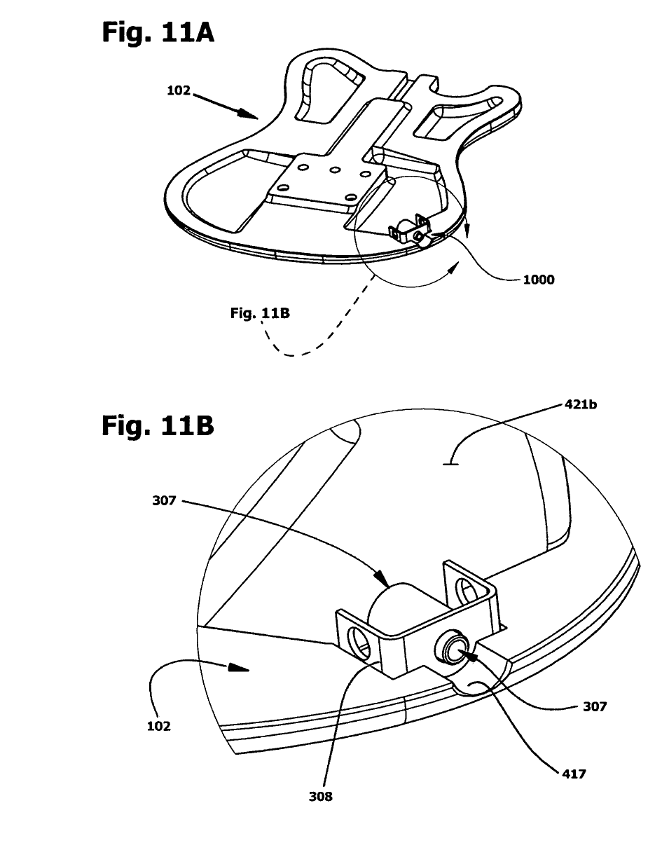

Turning now to FIG. 11, the front body plate shown in FIG. 10 has been removed in order to show the internally integrated output jack assembly 1000 as mounted to the back body member. Enlarged FIG. 11B shows a preferred embodiment, which consists of a U-shaped jack mounting bracket 308, to which the output jack and housing 307 is mounted within acoustic cavity 421b. The bracket 308 is securely mounted in cutout 416 of back plate 102. In this preferred embodiment the jack bracket 308 does not impinge on the front body member 101 so as not to dampen plate vibrations.

FIG. 12 anticipates a genus of solid core elements. Each has a unique “footprint”, as shown here in coronal section without the front body plate in view. FIG. 12A shows a solid core with “tee-shaped” mounting surface similar to that of FIGS. 6 and 7. Raised mounting surface 315 (corresponding to glue joint 601) is a solid core element. Neck glue joints 606 and 607 form a second solid core element of lesser surface area. The solid core elements are generally contiguous and make up a solid core. Dead-ended hole 602 is for registration of the front and back plates during manufacture and assembly. Holes 401a/b accept tailpiece attachment hardware. Holes 402a/b accept bridge attachment hardware. Areas within the outline of the guitar body but outside the footprint of the solid core elements are capable of complex modal oscillations.

FIG. 12B shows a schematic of a curved acentric solid core element 1201 analogous to element 315 (FIG. 4) but the joint is held in place by bolts at 1202, 1203 and 1204, and optionally with glue. The solid core elements are generally contiguous. Holes 1203a/b accept tailpiece attachment hardware. Hole 1202b (and a corresponding attachment point on the top plate for the left bridge stud) accept bridge attachment hardware. Areas within the dotted outline of the guitar body but outside the solid core area containing solid core elements 1201 and neck tendon union are capable of complex modal oscillations.

Curved acentric solid core element 1201 also permits formation of a large dished-out acoustic cavity on the left side of the guitar under the bass strings, while suppressing the size of any acoustic cavity on the right side of the guitar under the treble strings. These kinds of configurations are anticipated to modulate the resonance and sustain of the guitar in complex ways as a function of excitation frequency.

FIG. 12C shows a schematic of a solid core similar to that of FIGS. 8 and 9. The mounting surface is shown as a standoff 1206 with holes 1207a/b located for attachment of the string attachment hardware of the tailpiece FIG. 8C. Areas within the dashed outline of the guitar body but outside the solid core area enclosing the solid core elements are capable of complex modal oscillations in the manner of a cantilever supported only at one end by a rigid core. The footprint of the rigid core is taken as the area in any coronal section through the interplate channel (ie. parallel to and within the interplate channel) that is occupied by solid core elements plus any area lying between any pair of solid core elements. This solid core area is thus triangular and extends from the standoff to the neck splice joint.

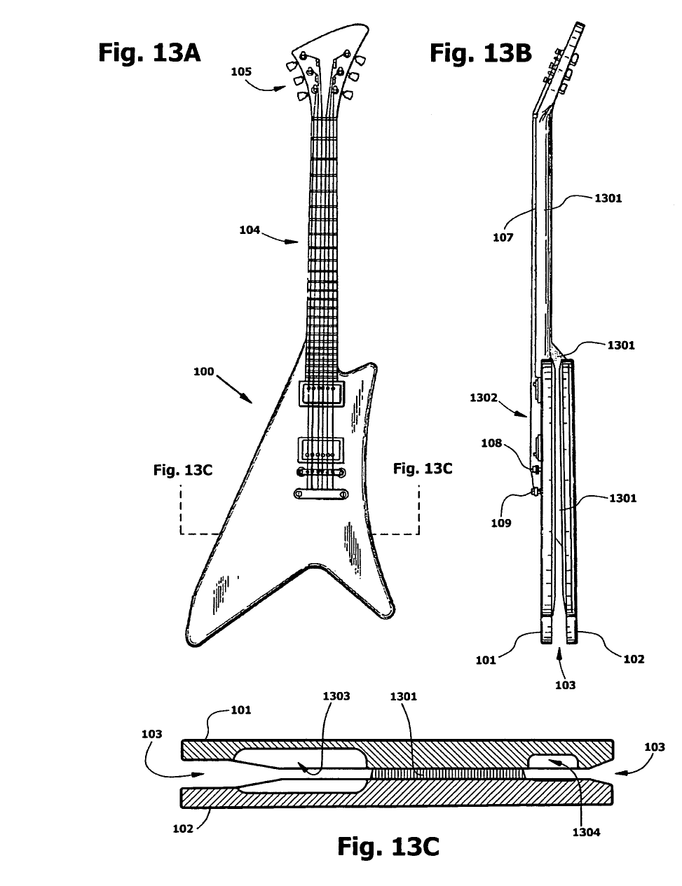

Turning to FIG. 13, we see another embodiment that anticipates a genus of solid body electric guitars 100. The split body feature is illustrated in FIG. 13B in elevation. Plates 101 and 102 are separated by an interplate channel 103 modified with acoustic cavities 1303 and 1304. A modified neck 104 and headstock 105 for this six-string (1302) guitar are also shown. Other body shapes are contemplated.

Cross-section 13C reveals an inner solid core element 1301. Elevation view 13B shows that this solid core element is continuous from cross-section 13C along neck 104 and through headstock 105. This monolithic neck, also termed a “through-neck”, adds stiffness to the guitar.

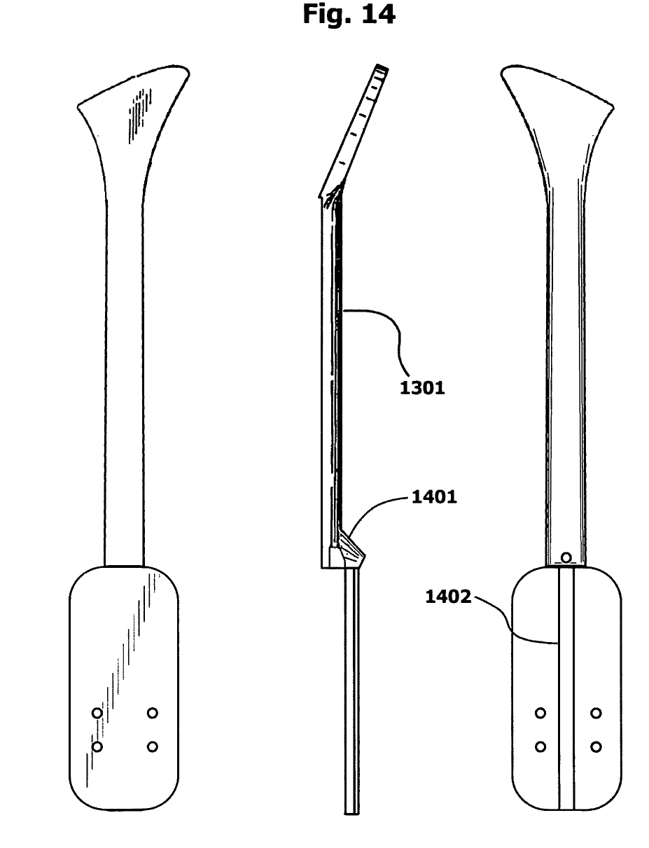

The solid core and neck construction of FIG. 13 leads us to FIG. 14, which shows the monolithic neck/solid core element 1301 in isolation. The stiffness of the piece can be increased by lamination, by the use of composite plastics, or by the use of a lightweight metal, for example as described in U.S. Pat. No. 4,616,548, adding to the sustain of the guitar. Integral truss design through the neck heel 1401 and solid core leads to stiffer solid body guitars. Mounting holes are provided for bridge and tailpiece hardware, and a toe 1402 on the reverse face projecting the length of the solid core is provided.

Other variations in the solid core are readily contemplated. In some embodiments, the front plate is not in contact with or joined to the neck head, but is instead mounted on a solid core having one or more solid core elements rising from the back plate. In other embodiments, the bridge and tailpiece mounting hardware is bolted to the front plate, and the only solid core element joining the front and back body plates is an extended tendon or tongue at the neck joint.

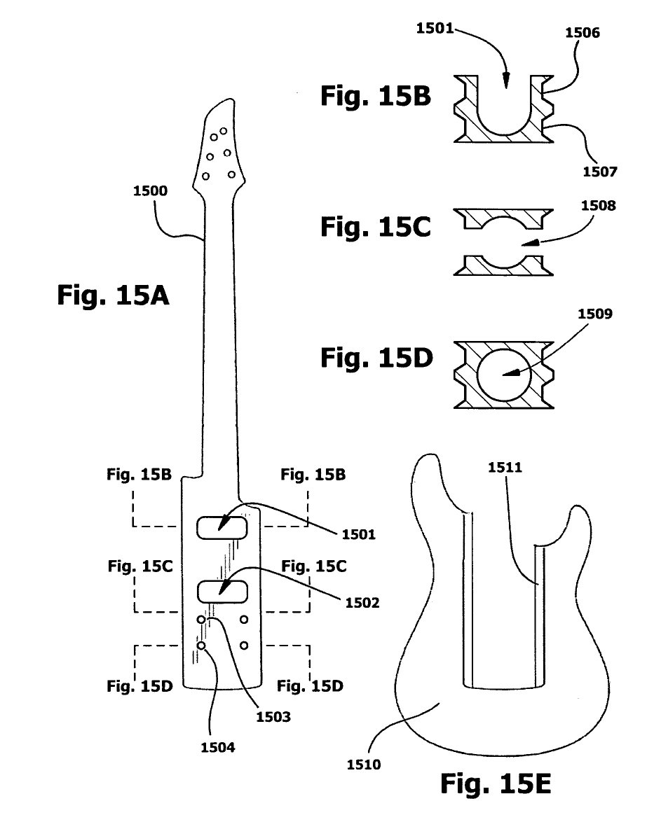

FIG. 15 shows a series of cross-sections through a solid beam 1500 or “through-neck” forming the neck and solid core element of a split-body guitar of the present invention. Here the plates do resemble shelves, but they are acoustically fused to the monolithic solid core. This again serves as an illustration of the genus of solid cores. Provision is provided for attachment of a bridge and tailpiece (or a combination thereof, such as for a bridge saddle with integrated tailpiece) at holes 1503 and 1504. Again the radial projections of the body plates are capable of complex modal oscillations.

The beam is optionally hollowed out as shown in FIGS. 15B, 15C, and 15D to lighten its weight and to accept electronic wiring and components. Bore 1509 is conceived as continuous from section 15B, through sections 15C and D, to the butt end of the beam. Receptacle 1501 in FIG. 15B is formed to accept an electromagnetic pickup. Similar construction is conceived for a second pickup 1502. The lateral anastomoses 1508 of FIG. 15C optionally are in acoustic communication with acoustic cavities formed in the interior of the front and back plates, any of which may serve as a housing for one or more microphonic pickups within the interplate channel (not shown).

A front plate member 1510 is shown in FIG. 15E. Note that shaped surface 1511 is designed to slide onto the upper cove or rabbet 1506. A second plate (not shown) is conceived to slide onto the lower cove or rabbet 1507. At least one plate is removable for service. The interplate separation distance or breadth is thus determined by the thickness of the plates and positioning of the cove or rabbet.

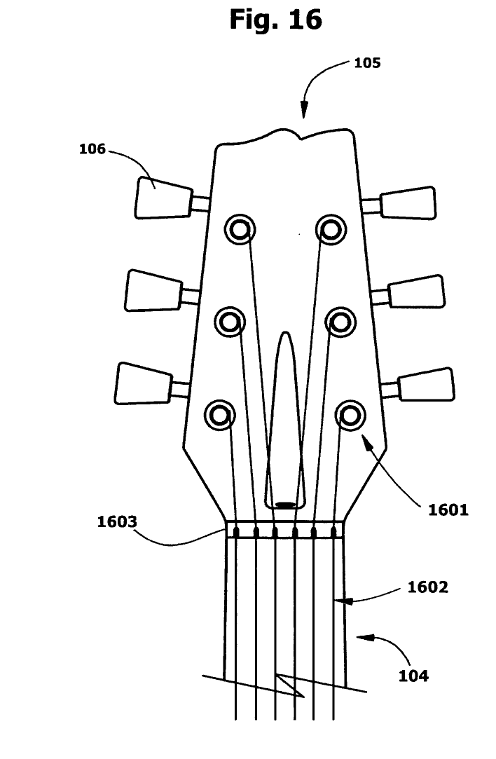

FIG. 16 shows a headstock 105 and neck 104 of an electric guitar with six strings 1602. A string tree 1601, tuning key mechanisms and knobs 106 are provided. A rigid “nut” (1603) is typically provided between the headstock and the fretboard. While there is a long tradition of six-string guitars, variations in the tuning key mechanism or placement, the number of strings, and the number of necks are well known in the art. Bass guitars conventionally have 4 strings.

A preferred embodiment of the present invention is shown FIGS. 1-7. Alternate forms are shown in FIGS. 8-9 and 12-15. In these designs, the solid body of the electric guitar or bass has a front body plate and a back body plate. The top and bottom faces of the body are usually coplanar. The plates are joined at a solid core, which is an essentially rigid volume extending from the top face to the bottom face of the guitar through the body plates. The radial projections of the body plates project from the solid core to the outside edge of the guitar body. These projections of the body plates vibrate when acoustically excited. While not bound by theory, the solid core thus functions as an acoustic nodal and the radial projections as acoustic antinodals and internodals, capable of complex acoustic modal figures and sympathetic vibration, thus causing air in the interplate channel to resonate and also dissipating the energy of the strings so as to create a unique acoustic signature. The front body plate and back body plate are separated by an interplate channel with breadth and depth.

The interplate channel may be dimensioned internally to form one or more acoustic chambers. In a preferred embodiment, an acoustic chamber is used to house electronic circuitry. A control interface is optionally mounted on the top face of the front body plate. [0136] Where used, the output jack socket attachment of FIGS. 10-11 is also unique. The jack is mounted to either the back body plate or the front body plate internally, with access through a receptacle dished out within the interplate channel. Optionally, a wireless transmitter may be used.

Where used, the neck joint of the embodiment of FIGS. 3-7 is also unique, whereby the body can be assembled in one step.

In my solid body designs, a pair of body plates are attached to each other only at a solid core. While not bound by theory, the radial and lateral projections of the plates from the solid core are free to oscillate when excited by plucking the strings in the manner of a cantilever supported at only one end or as the tongs of a three-dimensional tuning fork. These oscillations result in resonance, and also in dissipation of sound energy as heat. Unlike prior art designs, the entire area of the radial projections forming the front body plate of the guitar is free of attachment from the entire area of the radial projections forming the back body plate of the guitar, is separated by the interplate channel, and the only attachment between the two body plates is at the solid core. The radial projections are thus acoustically active. This activity can affect the output of pickups in various ways. I have found that these designs produce a signature sound that is rich, full bodied, and have a pleasing sustain. The acoustic signature can be modified by varying the mass of the plates, the type, size and location of solid core elements used, the nature of the materials, the number and configuration of acoustic chambers, and the internal dimensions of the interplate channel.

Although the above description and drawings contain specificities, these specificities should not be construed as limitations on the scope of the invention, but rather as exemplifications of embodiments of the invention. That is to say, the foregoing description of the invention is exemplary for purposes of illustration and explanation. Without departing from the spirit and scope of this invention, one skilled in the art can make changes and modifications to the invention to adapt it to various usages and conditions without inventive step. Any such changes and modifications are properly, equitably, and intended to be, within the full range of equivalence of the following claims. Thus the scope of the invention should be determined by the appended claims and their legal equivalents, when taken in light of the above specification.

### 3. EXAMPLES

### Example 1

A guitar of the present invention was constructed using a 3-axis CNC milling machine. The outlines of the front body plate and back body plate were cut from solid pieces of mahogany to proprietary blueprints. The neck was cut from solid mahogany, and the headstock and neck mounting surfaces were shaped as described in the figures. Recesses were routed for the pickups on the front of the front body plate. CNC milling was also used to carve out void volumes on the inside of the front body and back body plates and the electronics, output and power supply were mounted in the void volumes with nuts and washers. A bracket for the output jack was machined from metal and mounted at the lower margin of the body. The front body plate, back body plate, and neck were then glued together with Titebond woodworker's glue and clamped. After assembly of the solid body core, a bridge and tailpiece was mounted on the front body plate, a fretboard was mounted on the neck, and a nut was inserted in a groove in the neck abutting the headstock. Tuning keys were mounted in predrilled holes in the headstock and the strings were then mounted over the bridge.

### Example 2

The instrument of Example 1 was tuned and plugged into an amplifier. Surprisingly, without electronic amplification, plucking or strumming the strings instantly produced a full, mellow, melodious and richly colored tone that was pleasing to the ear. Comparisons with other electric guitars demonstrated that the tone of the prototype guitar was unique and instantly recognizable.

I claim:

1. An electric guitar or bass comprising a body with front body plate having top face and area in plan view, with back body plate having bottom face, and with outside edge, said top face and back face being generally coplanar, said front body plate and said back body plate being joined at a solid core extending vertically through said body from said top face to said bottom face, said front body plate further comprising radial projections projecting from said solid core to said outside edge, said back body plate further comprising radial projections projecting from said solid core to said outside edge, and further said radial projections of said front body plate being separated from said radial projections of said back body plate by an interplate channel with depth and breadth.

2. An electric guitar or bass of claim 1, wherein said solid core is essentially rigid, and said radial projections vibrate when acoustically excited.

3. An electric guitar or bass of claim 1, wherein said interplate channel is further dimensioned internally in the form of at least one acoustic chamber.

4. An electric guitar or bass of claim 3, wherein said at least one acoustic chamber houses electronic circuitry selected from the group consisting of op amp, bass control circuit, treble control circuit, tremolo control circuit, vibrato control circuit, wa-wa control circuit, battery, speaker, wireless transmitter, pickup selector, output jack, piezoelectric pickup, and microphonic pickup.

5. A electric guitar or bass of claim 4, wherein said electronic circuitry further comprises a control interface mounted on the top face of the front body plate.

6. An electric guitar or bass of claim 4, wherein the output jack is accessibly recessed within the interplate channel.

7. An electric guitar or bass of claim 6, wherein the output jack is mounted on a jack mounting bracket affixed to the back body plate.

8. An electric guitar or bass of claim 1, further comprising a pickup selected from the group consisting of electromagnetic pickup, piezoelectric pickup, and microphonic pickup.

9. An electric guitar or bass of claim 8, wherein the pickup is an electromagnetic pickup mounted to the front body plate.

10. An electric guitar or bass of claim 8, wherein the pickup is a piezoelectric pickup mounted in the string attachment mechanism.

11. An electric guitar or bass of claim 8, further comprising a plurality of pickups.

12. An electric guitar or bass of claim 1, wherein the solid core comprises at least one solid core element selected from stub, post, elevated flat, tendon, neck, centerbeam, or tongue.

13. An electric guitar or bass of claim 12, wherein the solid core further comprises at least one point of attachment for a string attachment mechanism.

14. An electric guitar or bass according to claim 12, wherein the elevated flat is a tee-shaped mounting surface.

15. An electric guitar or bass of claim 12, wherein the post is a round, the round having a centerhole for accepting a bushing.

16. An electric guitar or bass of claim 12, wherein the tendon is a neck tendon.

17. An electric guitar or bass of claim 12, wherein the centerbeam is a through-neck.

18. An electric guitar or bass of claim 12, wherein the neck is a through-neck.

19. An electric guitar or bass of claim 12, wherein the neck further comprises a neck splice joint.

20. An electric guitar or bass of claim 1, further comprising a neck with neck head, wherein the neck head is joined to the body at a neck splice joint.

21. An electric guitar or bass of claim 20, the neck splice joint further comprising a neck tendon, a neck undersurface, a neck toe, and mated surfaces on the body plates.

22. A method for assembling an electric guitar or bass, wherein a body and neck having neck splice joint, front body plate and back body plate are assembled by gluing at mated mounting surfaces in a single step.

23. An electric guitar or bass of claim 12, wherein the solid core occupies less than one half of the area of the top face in plan view, as calculated by adding any area in a coronal section through the interplate channel occupied by a solid core element plus all area lying between any pair of solid core elements.

24. An electric guitar or bass of claim 12, wherein the solid core comprises solid core elements that are generally contiguous.

25. An electric guitar or bass of claim 12, wherein the solid core is monolithic.

26. An electric guitar or bass according to claim 1, wherein the breadth of the interplate channel is greater than 0.5 mm and less than 7 cm, as measured between the body plates at the outside edge of the body.

27. An electric guitar or bass according to claim 26, wherein the breadth of the interplate channel is not a constant value.

28. An electric guitar or bass according to claim 1, wherein the body is constructed from wood, plastic, fiber composite, metal, or a combination thereof.

29. A solid body guitar or bass of claim 12 weighing less than 5 pounds.
